(19) United States
(12) Patent Application Publication
(10) Pub. No.: US 2006/0175973 A1
(43) Pub. Date: Aug. 10, 2006

(54) Xenon lamp

(76) Inventors: Igor V. Lisitsyn, Bainbridge, OH (US); Thomas L. Hardenburger, Claremont, CA (US)

Correspondence Address: PEARNE & GORDON LLP, 1801 EAST 9TH STREET, SUITE 1200, CLEVELAND, OH, 44114-3108, US

(21) Appl. No.: 11/052,254

(22) Filed: Feb. 7, 2005

(51) Int. Cl. H01J 17/04

(52) U.S. Cl. 313/631

(57) ABSTRACT

A xenon lamp includes a body with a cavity containing pressurized xenon gas. A window is mounted with respect to the cavity and a reflector surface is adapted to reflect light to pass through the cavity. The xenon lamp further includes an anode including an end portion and a cathode having an end portion with a tapered end located within the cavity. The anode and the cathode are positioned with a gap between the end portion of the anode and the tapered end of the cathode.

### FIELD OF THE INVENTION

The present invention relates to illumination devices, and more particularly to a xenon lamp illumination device.

### BACKGROUND OF THE INVENTION

Conventional xenon lamps are known to include a cathode and an anode disposed in a xenon atmosphere. FIGS. 1-3 provide a schematic illustration of conventional xenon lamp components wherein the figures are not necessarily to scale and the components are shown in schematic form with the actual shape, proportional relationship and other structural features not necessarily represented. As shown in FIG. 1, conventional lamps 100 include a body with a cavity 114 and a reflector surface 116. The reflector surface 116 includes a parabolic focal point “f” located in the cavity 114, wherein at least portions of the reflector surface are symmetrical about an axis of symmetry 150. An anode 118 is mounted with an end portion 120 positioned in the cavity. A cathode 126 is also provided with an end portion 128 including a tapered end 130 wherein the anode and cathode are positioned with a gap “g” between the end portion 120 of the anode 118 and the tapered end 130 of the cathode 126.

Conventional xenon lamps position the cathode 126 such that the tapered end 130 of the cathode 126 is located at an optimum point that is offset from the parabolic focal point “f” in a direction away from the reflector surface 116. The optimum point of the lamp can be determined experimentally and is the location on the axis of symmetry 150 where the lamp produces the most collimated light 170 in use. For example, as shown in FIG. 1, conventional lamps position the anode and cathode such that effective illumination from a hot spot 160 is substantially emitted from the focal point “f” of the lamp. Maximizing light emitted at the focal point “f” enhances the collimated light produced by the lamp in use.

As shown in FIG. 1, it is known to position the tapered end 130 at an optimum point located at a distance from 0.015 inches to 0.02 inches from the focal point “f” in a direction away from the reflector surface. For example, at one extreme, the tapered end 130 (shown in solid lines in FIG. 1) is known to be initially positioned at an optimum point of 0.015 inches from the focal point “f” in a direction away from the reflector surface 116. In another extreme, the tapered end 130 (shown in broken lines in FIG. 1) is known to be initially positioned at an optimum point of 0.02 inches from the focal point “f” in a direction away from the reflector surface 116. At both extremes and within the range between 0.015 inches to 0.02 inches, the gap distance “g” between the tapered end 130 and the end portion 120 is typically 0.04 to 0.05 inches.

Conventional xenon lamps are typically arranged with the tapered end 130 located at the optimum point of the lamp to provide optimum illumination characteristics when the lamp is first installed. However, over time, the tapered end 130 degrades, thereby adversely affecting illumination and/or reflection capabilities of the lamp. Lamp degradation, for example, can be caused by attrition of the tapered end that can affect the size and/or location of the hot spot 160. For example, as shown in FIG. 2, a conventional cathode 126 has an end portion 128 with a relatively sharp tapered end 130a located at the optimum point of the lamp. However, over time, the tapered end undergoes attrition such that a relatively blunt tapered end 130b remains as shown in FIG. 3. As portions of the sharp tapered end 130a have been removed by attrition, the relatively blunt tapered end 130b shifts away from the optimum point of the lamp in a direction away from the reflector surface 116. Consequently, the effective illumination from the hot spot 160 is substantially emitted from a location shifted away from the focal point “f” of the lamp in a direction away from the reflector surface 116. Optimal reflection capabilities of the parabolic reflector surface are adversely affected as the hot spot 160 is not effectively emitting light from the focal point “f”. In addition, the relatively sharp tapered end 130a can produce a hot spot 160 having a relatively smaller diameter when compared to the diameter of the hot spot 160 produced by the relatively blunt tapered end 130b. Providing a hot spot with a smaller diameter can provide better lamp performance when compared with a hot spot having a larger diameter. For example, increasing the diameter of the hot spot can cause the hot spot to emit light that is partially blocked by the anode that might not otherwise have occurred if the hot spot was formed with a relatively smaller diameter.

### SUMMARY OF THE INVENTION

In accordance with one aspect, a xenon lamp is provided with a body including a cavity and a reflector surface adapted to reflect light to pass through the cavity. The xenon lamp further includes anode including an end portion and a cathode having an end portion with a tapered end located within the cavity. The anode and the cathode are positioned with a gap between the end portion of the anode and the tapered end of the cathode. A window is mounted with respect to the cavity, wherein the cavity includes pressurized xenon gas with a cold fill gauge pressure of greater than 350 psi and less than about 500 psi.

In accordance with another aspect, a xenon lamp is provided with a body including a cavity containing pressurized xenon gas. A window is mounted with respect to the cavity and a reflector surface is adapted to reflect light to pass through the cavity. The reflector surface includes a parabolic cross section and a parabolic focal point located in the cavity. At least portions of the reflector surface are symmetrical about an axis of symmetry extending through the parabolic focal point. The xenon lamp further includes an anode including an end portion and a cathode having an end portion. The end portion of the cathode includes a tapered end located within the cavity with the axis of symmetry extending through the tapered end. The anode and the cathode are positioned with a gap between the end portion of the anode and the tapered end of the cathode. The tapered end of the cathode is located closer to the reflector surface than an optimum point of the lamp.

In accordance with a further aspect, a xenon lamp is provided with a body including a cavity containing pressurized xenon gas having a cold fill gauge pressure of greater than about 375 psi and less than about 500 psi. A window is mounted with respect to the cavity and a reflector surface is adapted to reflect light to pass through the cavity. The reflector surface includes a parabolic cross section and a parabolic focal point located in the cavity. At least portions of the reflector surface are symmetrical about an axis of symmetry extending through the parabolic focal point. The xenon lamp further includes an anode including an end portion and a cathode including an end portion. The end portion of the anode includes a substantially flat surface and a chamfer circumscribing the substantially flat surface. The end portion of the cathode includes a tapered end located within the cavity with the axis of symmetry extending through the tapered end. The anode and the cathode are positioned with a gap between the end portion of the anode and the tapered end of the cathode. The tapered end of the cathode is located closer to the reflector surface than an optimum point of the lamp.

### BRIEF DESCRIPTION OF THE DRAWINGS

FIG. 1 is a schematic illustration of components of a conventional xenon lamp;

FIG. 2 is a schematic illustration of components of a conventional xenon lamp producing an initial hot spot near the beginning of the lamp life cycle;

FIG. 3 is a schematic illustration of components of a conventional xenon lamp producing a subsequent hot spot near the end of the lamp life cycle;

FIG. 4 is a side elevational view of a xenon lamp in accordance with an exemplary embodiment of the present invention;

FIG. 5 is a front elevational view of the xenon lamp of FIG. 4;

FIG. 6 is a rear elevational view of the xenon lamp of FIG. 4;

FIG. 7 is a sectional view of the xenon lamp along line 7-7 of FIG. 4; and

FIG. 8 is an enlarged view of portions of the xenon lamp taken at view 8 of FIG. 7.

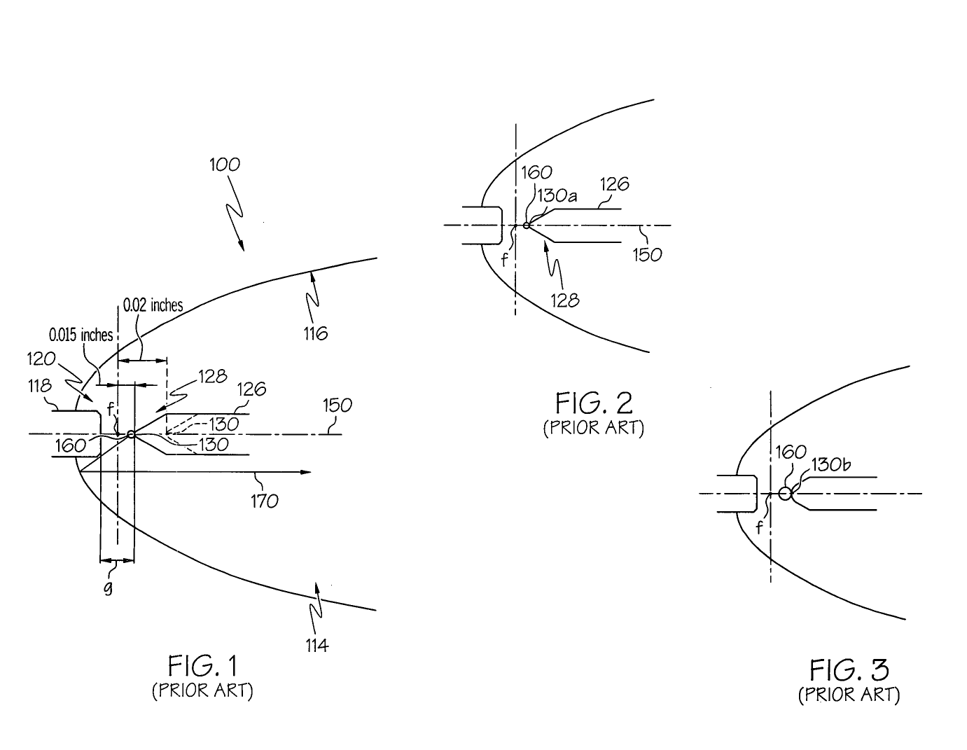

### DETAILED DESCRIPTION OF EXAMPLE EMBODIMENTS

Xenon lamps of the present invention can have a wide range of applications. For example, xenon lamps may be used as a light source for fiberoptic applications, projection television systems, or endoscope devices adapted to perform surgical procedures or inspections in otherwise nonaccessible areas. It will be appreciated that xenon lamps presented herein may be used with other alternative applications requiring a light source.

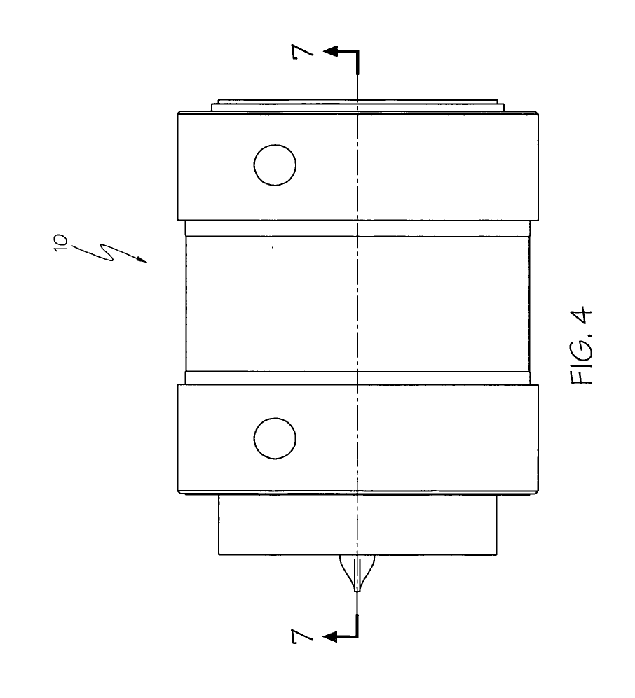

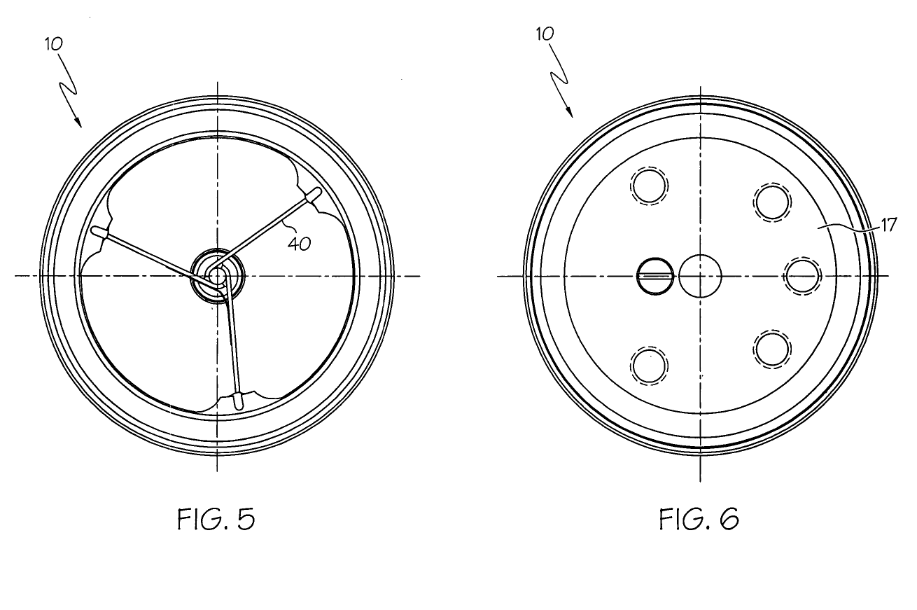

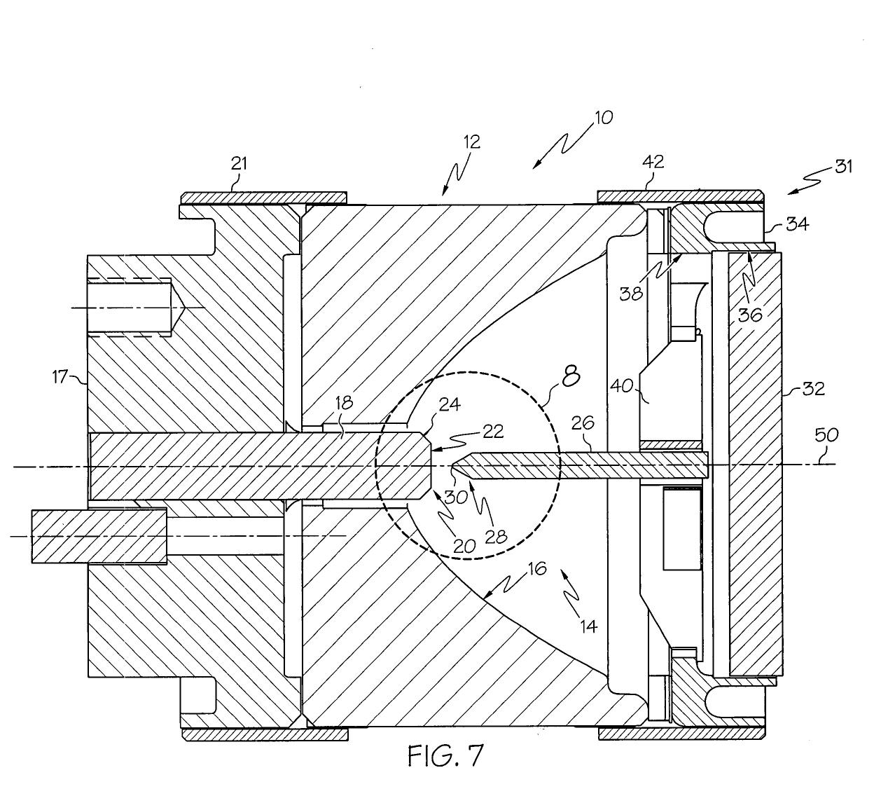

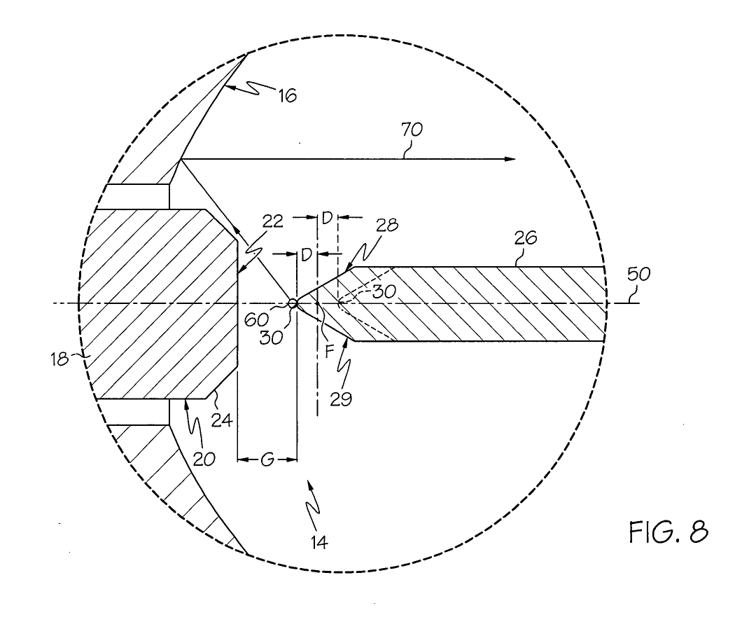

The concepts of the present invention may be incorporated in xenon lamps having a wide range of structure and components. Just one example of a xenon lamp 10 incorporating concepts of the present invention is illustrated in FIGS. 4-8. FIGS. 4-6 depict a side, front and rear elevational view, respectively, of the exemplary xenon lamp 10. FIG. 7 depicts a sectional view of the xenon lamp 10 along line 7-7 of FIG. 4. As shown, the xenon lamp 10 includes a body 12 including a cavity 14. Embodiments of the present invention may provide a ceramic body 12 although other materials may be used in accordance with the concepts of the present invention. In embodiments formed with a ceramic body, the ceramic material might comprise a 94%-98% alumina ceramic, for example.

The xenon lamp further includes a reflector surface 16 adapted to reflect light 70 to pass through the cavity 14. The reflector surface can comprise a layer of additional reflective material, a polished or treated surface of the body and/or can comprise a boundary of the cavity 14. As shown, embodiments of the present invention might include a shaped reflector surface adapted to reflect light through the cavity in a desirable manner. For example, the reflector surface can have a stepped or continuous parabolic cross section, although elliptical, or other cross sectional shapes are contemplated.

The xenon lamp also includes an anode 18 including an end portion 20. As shown, in exemplary embodiments, the end portion 20 of the anode 18 can extend at least partially into the cavity 14 although it is contemplated that the end portion might be flush with a surface of the body 12 or countersunk within the body 12 in additional embodiments. The end portion 20 of exemplary anodes can include a chamfer 24 although non-chamfered anodes may be used in accordance with exemplary embodiments of the invention. Embodiments including a chamfer 24 can include a chamfer circumscribing a central area of the anode. Alternatively, or in addition, the end portion 20 of the anode may comprise a substantially flat surface 22 facing a cathode 26. Embodiments including an anode with a substantially flat surface 22 may further include a chamfer 24 that might circumscribe the substantially flat surface 22 as shown in FIGS. 7 and 8. As shown in FIG. 8, providing a chamfer may be desirable to permit passage of light rays 70 to be reflected from the reflector surface 16 that otherwise would have been blocked by corner portions of the anode.

Xenon lamps 10 further include a cathode 26 having an end portion 28 including a tapered end 30. As shown the tapered end is a slightly rounded tip of a conical surface 29. In further examples, the tapered end 30 might comprise a sharp tip, rather than slightly rounded tip. However, providing a tapered end 30 having a slightly rounded tip can avoid delicate portions prone to a relatively high initial attrition rate at the beginning of the lamp life cycle. Although the illustrated embodiment discloses a conical tapered end, it is contemplated that the tapered end may have shapes other than conical wherein a cross sectional width of the end portion 28 decreases towards the tapered end 30.

The anode 18 and the cathode 26 are positioned with a gap “G” between the end portion 20 of the anode 18 and the tapered end 30 of the cathode 26. Although various gap distances are contemplated, exemplary arrangements may be provided with a gap distance “G” of from about 0.04 to about 0.05 inches. The anode 18 and/or the cathode 26 can be formed from tungsten, such as a 2% thoriated tungsten. In further examples, the anode 18 and/or cathode 26 can be formed from alternative materials while incorporating the concepts of the present invention.

Xenon lamps 10 according to the present invention further include a window 32 mounted with respect to the cavity 14. The window can comprise a sapphire window although other windows may be used in accordance with the present invention.

In exemplary embodiments, the window can 32 can be mounted directly to the body 12 to seal the cavity 14. In the illustrated embodiments, the window 32 may be provided as part of an assembly 31 adapted to mount the window 32 to the body 12 wherein the cavity may be pressurized with xenon gas. In accordance with exemplary embodiments of the present invention, the xenon gas within the cavity may be pressurized with a cold fill gauge pressure of greater than 350 psi although pressures above or below 350 psi may be used in accordance with aspects of the present invention. Providing a gauge pressure of greater than 350 psi can reduce the diameter of the hot spot 60 and thereby provide better lamp performance when compared to hot spots having a relatively larger diameter with a gauge pressure of less than 350 psi. For example, reducing the diameter of the hot spot can increase the amount of light that is not blocked by the anode. In examples, the pressurized xenon gas has a cold fill gauge pressure of greater than 350 psi and less than about 500 psi. In further examples, the pressurized xenon gas has a cold fill gauge pressure of greater than about 375 psi and less than about 500 psi. In still further examples, the pressurized xenon gas has a cold fill gauge pressure of greater than about 375 psi and: less than about 425 psi.

The assembly 31 may also be adapted to support the cathode 26 within the cavity by way of a web support structure 40. For example, the assembly 31 can include a J-ring 34 adapted to support the window 32 and the cathode 26 with respect to the body 12. As shown, a first inner circumferential surface 36 is adapted to circumscribe and support the window 32 and a second inner circumferential surface 38 is adapted to support the web support structure 40. A ring 42 can be provided to attach the J-ring 34 to the body 12.

The xenon lamp 10 can also include an anode base 17 mounted to the body 12 with a mounting ring 21. The anode base may comprise core iron bar although other materials may be used in accordance with concepts of the present invention.

As shown in FIG. 8, exemplary xenon lamps 10 can include a reflector surface 16 including a parabolic cross section and a parabolic focal point “F” located in the cavity 14. At least portions of the reflector surface are symmetrical about an axis of symmetry 50 extending through the parabolic focal point “F”. The lamp 10 further includes an optimum point. The optimum point of the lamp 10 can be determined experimentally and is the location of the tapered end 30 on the axis of symmetry 50 where the lamp 10 would produce the most collimated light in use.

In exemplary embodiments, the tapered end 30 might be initially located at the optimum point of the lamp. In further exemplary embodiments of the present invention, the tapered end 30 of the cathode 26 is located closer to the reflector surface 16 than the optimum point of the lamp. Therefore, in accordance with aspects of the present invention, the tapered end 30 of the cathode 26 might be initially located such that the lamp 10 does not initially produce the most collimated light in use. However, as the tapered end 30 of the cathode 26 degrades, the tapered end 30 shifts to a point closer to the optimum point and might even degrade through the optimum point over time. Initially positioning the cathode at the optimum point can maximize initial illumination capabilities of the lamp but might eventually result in undesirable illumination capabilities as the tapered end degrades. Alternatively, positioning the tapered end 30 of the cathode at a position closer to the optimum point of the lamp might reduce initial illumination capabilities of the lamp but can result in desirable illumination capabilities over a longer period of time as the tapered end degrades. For example, as the tapered end degrades, its location approaches the optimum position of the lamp. In certain instances, the tapered end may degrade such that its location passes through the optimum position during the life of the lamp. Thus, by locating the tapered end 30 of the cathode at a location closer to the reflector surface 16 than the optimum point of the lamp, overall lamp performance can be enhanced over the life of the lamp.

As shown in the exemplary embodiment of FIG. 8 the tapered end 30 of the cathode 26 might be located a distance of about “D” or less from the focal point such that the tapered end of the cathode is located closer to the reflector surface than the optimum point of the lamp. For example, in one extreme, the tapered end 30 (shown in solid lines in FIG. 8) can be located further into the cavity a distance of about “D” or less from the focal point “F” in a direction toward the reflector surface 16. At the other extreme, the tapered end 30 (shown in broken lines in FIG. 8) can be located a distance on the opposite side of the focal point “F” of about “D” or less from the focal point “F” in a direction away from the reflector surface 16.

Various dimensions might be provided depending on the size and characteristics of the lamp. In one example, the tapered end 30 of the cathode can be located a distance “D” of about 0.01 inches or less from the parabolic focal point “F”. In further examples, the tapered end 30 of the cathode can be located a distance “D” of about 0.005 inches or less from the parabolic focal point “F”. Location of the tapered end 30 of the cathode at a distance of “D” of about 0.01 inches or less from the parabolic focal point “F”, such as 0.005 inches or less from the parabolic focal point “F”, can enhance illumination characteristics throughout the life of the xenon lamp. It is also appreciated that, depending on the size and characteristics of the lamp, the tapered end 30 of the cathode can be positioned at a location of greater than 0.01 inches from the focal point with the tapered end of the cathode being located closer to the reflector surface than the optimum point of the lamp. Such positioning of the tapered end 30 accommodates for further attrition of the tapered end 30 throughout the life of the lamp; thereby providing overall enhanced lamp performance over the life of the lamp. Still further, the xenon gas may also be pressurized with a cold fill gauge pressure of greater than 350 psi, as discussed above, to further enhance the illumination characteristics of the xenon lamp.

From the above description of the invention, those skilled in the art will perceive improvements, changes and modifications. Such improvements, changes and modifications within the skill of the art are intended to be covered by the appended claims.

What is claimed:

1. A xenon lamp comprising.
a body including a cavity;
a reflector surface adapted to reflect light to pass through the cavity;
an anode including an end portion;
a cathode having an end portion including a tapered end located within the cavity, wherein the anode and the cathode are positioned with a gap between the end portion of the anode and the tapered end of the cathode; and
a window mounted with respect to the cavity, wherein the cavity includes pressurized xenon gas with a cold fill gauge pressure of greater than 350 psi and less than about 500 psi.

2. The xenon lamp of claim 1, wherein the pressurized xenon gas has a cold fill gauge pressure of greater than about 375 psi and less than about 500 psi.

3. The xenon lamp of claim 1, wherein the pressurized xenon gas has a cold fill gauge pressure of greater than about 375 psi and less than about 425 psi.

4. The xenon lamp of claim 1, wherein the reflector surface has a parabolic cross section.

5. The xenon lamp of claim 1, wherein the end portion of the anode has a chamfer.

6. The xenon lamp of claim 1, wherein the end portion of the anode includes a substantially flat surface facing the cathode.

7. The xenon lamp of claim 6, wherein the end portion of the anode further includes a chamfer circumscribing the substantially flat surface.

8. A xenon lamp comprising:
a body including a cavity containing pressurized xenon gas;
a window mounted with respect to the cavity;
a reflector surface adapted to reflect light to pass through the cavity, the reflector surface including a parabolic cross section and a parabolic focal point located in the cavity, wherein at least portions of the reflector surface are symmetrical about an axis of symmetry extending through the parabolic focal point;
an anode including an end portion; and
a cathode having an end portion including a tapered end located within the cavity with the axis of symmetry extending through the tapered end, wherein the anode and the cathode are positioned with a gap between the end portion of the anode and the tapered end of the cathode, and wherein the tapered end of the cathode is located closer to the reflector surface than an optimum point of the lamp.

9. The xenon lamp of claim 8, wherein the tapered end of the cathode is located about 0.01 inches or less from the parabolic focal point.

10. The xenon lamp of claim 9, wherein the tapered end of the cathode is located about 0.005 inches or less from the parabolic focal point.

11. The xenon lamp of claim 8, wherein the pressurized xenon gas has a cold fill gauge pressure of greater than 350 psi and less than about 500 psi.

12. The xenon lamp of claim 8, wherein the pressurized xenon gas has a cold fill gauge pressure of greater than about 375 psi and less than about 500 psi.

13. The xenon lamp of claim 8, wherein the pressurized xenon gas has a cold fill gauge pressure of greater than about 375 psi and less than about 425 psi.

14. The xenon lamp of claim 8, wherein the end portion of the anode has a chamfer.

15. The xenon lamp of claim 8, wherein the end portion of the anode includes a substantially flat surface facing the cathode.

16. The xenon lamp of claim 15, wherein the end portion of the anode further includes a chamfer circumscribing the substantially flat surface.

17. A xenon lamp comprising:
a body including a cavity containing pressurized xenon gas having a cold fill gauge pressure of greater than about 375 psi and less than about 500 psi;
a window mounted with respect to the cavity;
a reflector surface adapted to reflect light to pass through the cavity, the reflector surface including a parabolic cross section and a parabolic focal point located in the cavity, wherein at least portions of the reflector surface are symmetrical about an axis of symmetry extending through the parabolic focal point;
an anode including an end portion with a substantially flat surface and a chamfer circumscribing the substantially flat surface; and
a cathode having an end portion including a tapered end located within the cavity with the axis of symmetry extending through the tapered end, wherein the anode and the cathode are positioned with a gap between the end portion of the anode and the tapered end of the cathode, and wherein the tapered end of the cathode is located closer to the reflector surface than an optimum point of the lamp.

18. The xenon lamp of claim 17, wherein the cold fill gauge pressure is greater than about 375 psi and less than about 425 psi.

19. The xenon lamp of claim 16, wherein the tapered end of the cathode is located about 0.01 inches or less from the parabolic focal point.

20. The xenon lamp of claim 19, wherein the tapered end of the cathode is located about 0.005 inches or less from the parabolic focal point.
